(19) United States
(12) Patent Application Publication
(10) Pub. No.: US 2024/0320996 A1
(43) Pub. Date: Sep. 26, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: RYO KOSAKA, Tokyo (JP)

(21) Appl. No.: 18/604,347

(22) Filed: Mar. 13, 2024

(30) Foreign Application Priority Data
Mar. 20, 2023 (JP) 2023-043940

(51) Int. Cl. G06V 30/416; G06V 30/12; G06V 30/19

(52) U.S. Cl. CPC G06V 30/416; G06V 30/127; G06V 30/19153; G06V 30/19147

(57) ABSTRACT

Provided is an information processing apparatus including: an obtaining unit configured to obtain a token string generated based on character strings included in a document image; a first determination unit configured to determine a document type represented by the document image and character strings corresponding to a first item included in the document image by using a result obtained by inputting the token string into a trained model; and a second determination unit configured to determine a character string corresponding to a second item by applying the document type and the character strings corresponding to the first item to a rule-based algorithm.

### BACKGROUND

### Field

The present disclosure relates to processing for extracting data from a document image.

### Description of the Related Art

There have been methods for extracting character strings (item values) corresponding to predetermined items from a document image obtained by scanning a document. The extracted character strings are used as the file name, data to be input into a work system, and so on.

Japanese Patent Laid-Open No. 2020-13281 discloses a method in which a group of character strings extracted from a form are each given a tag by using a trained model obtained by performing machine learning on the correspondence between the positions of extracted character strings and tags to be given to the character strings at these positions. Japanese Patent Laid-Open No. 2020-13281 further discloses that the tagged character strings are used to generate structured data in which item names and item values are associated with each other by following a format set for the form type.

Incidentally, one may wish to extract, from among the character strings in a document, character strings such as the company name of the issuance destination of the document and the company name of the issuance source of the document. However, depending on the document, the company name of the issuance destination can be the company name of a billing destination or the company name of the issuance source can be the company name of the billing destination, for example. Thus, in a case where one attempts to generate a trained model that estimates character strings such as the company names of an issuance destination and an issuance source, it will be impossible to appropriately generate it by a method involving learning the correspondence of character strings like Japanese Patent Laid-Open No. 2020-13281. More training data will be required in order to cover all conditions. This will lead to an increased burden such as an increased cost or time for generating the trained model.

### SUMMARY

An information processing apparatus of the present disclosure includes: an obtaining unit configured to obtain a token string generated based on character strings included in a document image; a first determination unit configured to determine a document type represented by the document image and character strings corresponding to a first item included in the document image by using a result obtained by inputting the token string into a trained model; and a second determination unit configured to determine a character string corresponding to a second item by applying the document type and the character strings corresponding to the first item to a rule-based algorithm.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an information processing system;

FIGS. 2A to 2C are diagrams illustrating an example of documents;

FIGS. 3A to 3C are diagrams illustrating an example of the hardware configurations of an image forming apparatus, a training apparatus, and an information processing apparatus;

FIGS. 4A and 4B are diagrams illustrating sequences by the information processing system;

FIG. 5 is a flowchart describing details of processes executed by the training apparatus;

FIGS. 6A to 6D are diagrams for describing a document image sample;

FIG. 7 is a flowchart for describing details of a process of generating a document image token string;

FIGS. 8A to 8D are diagrams for describing the process of generating a document image token string;

FIGS. 9A and 9B are diagrams for describing the process of generating an item value token string;

FIG. 10 is a flowchart describing details of a process of determining extraction target character strings;

FIGS. 11A to 11C are diagrams for describing the process of determining extraction target character strings;

FIGS. 12A to 12C are diagrams for describing the process of determining extraction target character strings;

FIG. 13 is a flowchart for describing an extraction target character string determination algorithm;

FIGS. 14A and 14B are diagrams for describing the result of the determination of extraction target character strings;

FIG. 15 is a flowchart for describing a process of determining extraction target character strings;

FIGS. 16A and 16B are diagrams for describing the result of the determination of extraction target character strings;

FIGS. 17A and 17B are diagrams for describing the result of determination of extraction target character strings;

FIG. 18 is a diagram illustrating changed degrees of priority corresponding to a buyer's statuses; and

FIGS. 19A to 19D are diagrams for describing another example of extraction target items.

### DESCRIPTION OF THE EMBODIMENTS

Embodiments of the technique of the present disclosure will be described using the drawings. Note that the components described in the following embodiments are exemplary and are not intended to limit the technical scope of the present disclosure.

### First Embodiment

### [Configuration of Information Processing System]

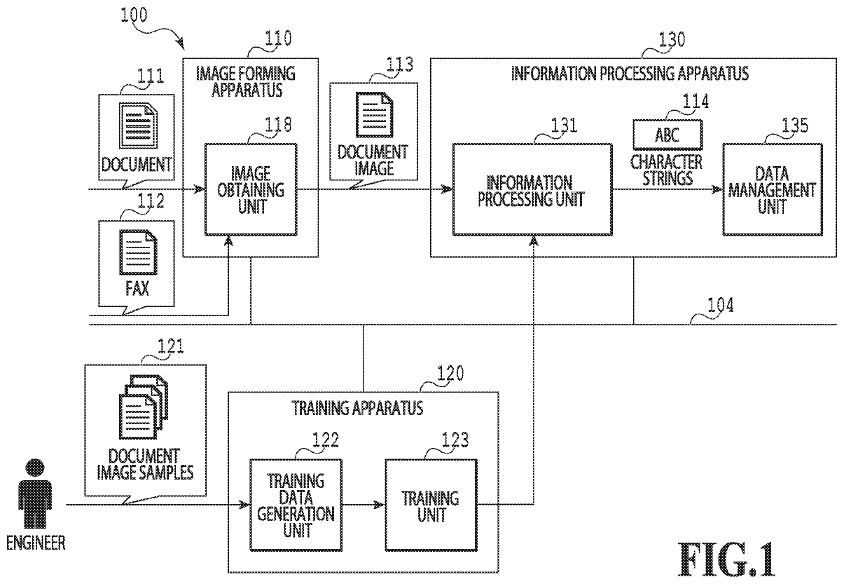

FIG. 1 is a diagram illustrating an example configuration of an information processing system 100. As illustrated in FIG. 1, the information processing system 100, for example, has an image forming apparatus 110, a training apparatus 120, and an information processing apparatus 130, which are connected to one another through a network 104. The information processing system 100 may be configured such that the image forming apparatus 110, the training apparatus 120, and the information processing apparatus 130 each have multiple connections to the network 104, instead of a single connection. For example, the configuration may be such that the information processing apparatus 130 includes a first server apparatus having a high-speed computation resource and a second server apparatus having a high-volume storage, which are connected to each other through the network 104.

The image forming apparatus 110 is implemented with a multi-function peripheral (MFP) having multiple functions such as printing, scanning, and faxing, or the like. The image forming apparatus 110 has at least an image obtaining unit 118 as a functional unit.

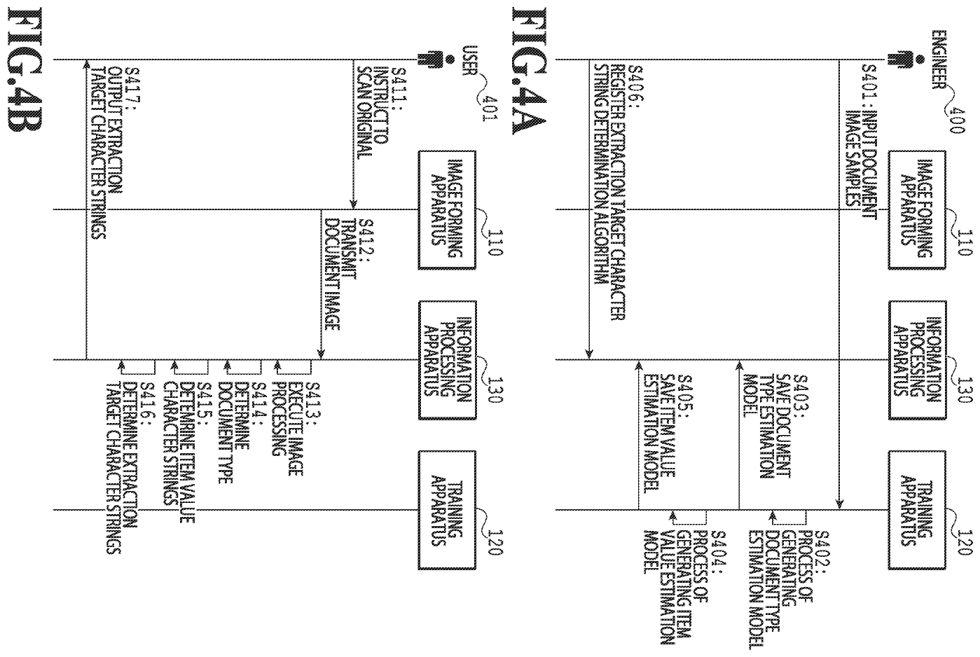

The image forming apparatus 110 has a scanner device 306 (see FIG. 3). The scanner device 306 optically reads a document 111 being a print medium, such as paper, on which character strings are printed, and the image obtaining unit 118 performs predetermined image processing on the data thus obtained to generate a document image 113. Also, the image obtaining unit 118, for example, receives fax data 112 transmitted from a fax transmitter not illustrated and performs predetermined fax image processing to generate the document image 113. The image obtaining unit 118 transmits the generated document image 113 to the information processing apparatus 130.

The image forming apparatus 110 may be configured to be implemented with a personal computer (PC) or the like, instead of an MFP having scanning and faxing functions as mentioned above. For example, the document image 113 in a format such as PDF or JPEG generated using a document creation application that runs on the PC may be transmitted to the information processing apparatus 130.

The training apparatus 120 has a training data generation unit 122 and a training unit 123 as functional units.

The training apparatus 120 receives multiple document image samples 121 provided by an engineer, document type information of each document image sample, data of the character strings included in each document image sample, and item value information to be extracted.

The training data generation unit 122 generates a document image token string from each document image sample 121. The training data generation unit 122 also embeds item value information to be extracted in each of the tokens in the generated document image token string to generate an item value token string. Details of the document image token string and the item value token string will be described later.

The training unit 123 generates a document type estimation model which is a trained model that estimates the document type of a document image by using training data in which document image token strings and pieces of document type information are paired. The training unit 123 also generates an item value estimation model which is a trained model that estimates item values included in a document image by using training data in which document image token strings and item value token strings are paired.

The information processing apparatus 130 has an information processing unit 131 and a data management unit 135 as functional units.

The information processing unit 131 determines the document type of the document image 113 by using the document type estimation model generated by the training apparatus 120. The information processing unit 131 also determines character strings (item values) corresponding to predetermined item names out of character string data contained in the document image 113 by using an item value estimation model. Then, the information processing unit 131 inputs the determined document type and item values into an extraction target character string determination algorithm in which determination conditions for determining the issuance source and the issuance destination have been set in advance by the engineer. Thereafter, the information processing unit 131 determines extraction target character strings 114 as character strings corresponding to extraction target items. In a case where the user issues an instruction to make a correction, the information processing unit 131 corrects the extraction target character strings 114 to character strings designated by the user. The information processing unit 131 is capable of updating information of the extraction target character string determination algorithm based on character strings designated by the user. Details of the processing by the information processing unit 131 will be described later.

The data management unit 135 stores data of the extraction target character strings 114 determined by the information processing unit 131.

The network 104 is implemented as a local area network (LAN), a wide area network (WAN), or the like, and is a communication unit that connects the image forming apparatus 110, the training apparatus 120, and the information processing apparatus 130 to one another for data communication between these apparatuses.

### [Extraction Target Items and Extraction Target Character Strings]

There is a method of extracting character strings (item values) corresponding to predetermined items from a document image created with an unusual layout called a semi-standardized document or a non-standardized document. For example, there is a case where the names of multiple companies and the names of multiple persons in charge are written on a form. In this case, by using a trained model obtained by machine learning on positional relationships between character strings, it will be possible to extract the company names, the person-in-charge names, or the like of the billing destination and the delivery destination from the description of the document. Here, in a case of using a similar method to extract character strings corresponding to the company names or person-in-charge names of the issuance source and the issuance destination of a document as extraction target character strings, it may be difficult to extract those character strings.

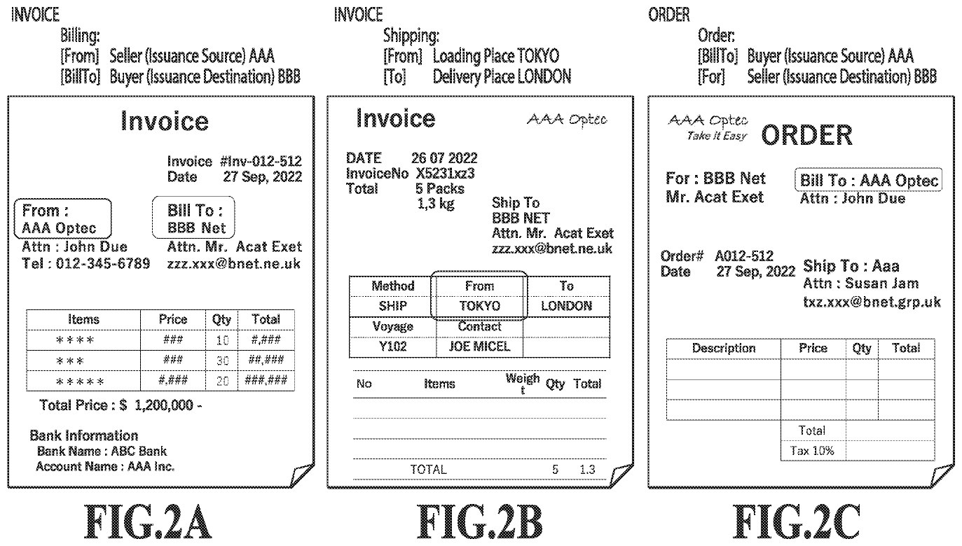

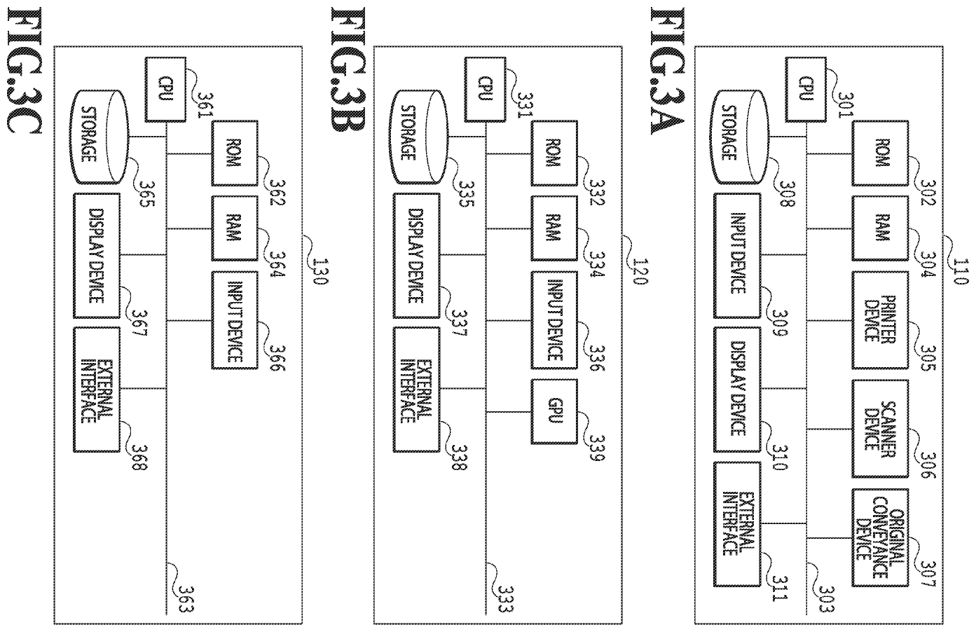

FIG. 2A is a diagram illustrating an example of a document whose document type is an invoice. The company name of the issuance source of the document of FIG. 2A is “AAA Optec” written under “From”. Now, assume that a trained model that estimates an issuance destination or an issuance source is generated by causing it to learn the contents of the character strings in documents like FIG. 2A and the positional relationship between the character strings. In this case, it is possible that this trained model will output a character string near “From” as the company name of an issuance source. Here, there are documents on which a loading place is written under “From”, like the document of FIG. 2B. For this reason, in a case of inputting the document of FIG. 2B into a trained model trained using documents like FIG. 2A, there is a possibility of failing to extract the character string indicating the issuance source of the document.

Also, the company name of the issuance destination of the document of FIG. 2A is “BBB Net”, which is the company name of the buyer in FIG. 2A, written under “Bill to”. On the other hand, in the document of FIG. 2C, whose document type is a purchase order, “AAA Optec” near “Bill to”, which is the company name of the buyer in FIG. 2C, is the company name of the issuance source. As described above, depending on the document, the company name of a buyer can be the company name of the issuance destination of the document or of the issuance source of the document. For this reason, in a case of inputting the document of FIG. 2C into a trained model trained using documents like FIG. 2A, there is a possibility of failing to extract the character string of the issuance destination or the issuance source of the document.

To generate a trained model capable of outputting the appropriate issuance source and issuance destination from any one of the documents of FIGS. 2A, 2B, and 2C, it will be necessary to train the trained model by further taking document types, contents of work, and the like into account. Accordingly, a sufficient amount of training data will be needed to satisfy such requirements. Moreover, increasing the amount of the training data also increases the training time and the like. Consequently, there is a possibility of increased burdens such as an increased cost and time for generating the trained model.

Thus, in the present embodiment, a document type estimation model which estimates the document type of a document is generated as a trained model. In addition, an item value estimation model is generated which estimates a character string indicating the company name or the like of a buyer's status (such as a billing destination) and a character string indicating the company name or the like of a seller's status (such as a supplier) from among the character strings in a document. The character strings indicating the company name of the buyer's status and the company name of the seller's status are obtained as candidate character strings for the company names of the issuance destination and the issuance source. The document type estimation model and the item value estimation model can be generated by learning the contents of character strings included in documents and the positional relationship between the character strings. Accordingly, the document type estimation model and the item value estimation model can be generated with smaller amounts of training data and lower training costs than the trained model that estimates an issuance destination and an issuance source.

Moreover, in the present embodiment, the document type determined by using the document type estimation model and the candidate character strings for the issuance source and the issuance destination determined by using the item value estimation model are obtained. Then, the document type and the candidate character strings are applied to a rule-based algorithm (extraction target character string determination algorithm) to determine the character strings of the issuance destination and the issuance source of the document. By combining trained models and a rule-based algorithm as above, it is possible to determine appropriate extraction target character strings with less burdens.

### [Hardware Configuration of Image Forming Apparatuses]

FIGS. 3A to 3C are diagrams illustrating an example of the hardware configurations of the image forming apparatus 110, the training apparatus 120, and the information processing apparatus 130 included in the information processing system 100 in FIG. 1.

FIG. 3A is a diagram illustrating the hardware configuration of the image forming apparatus 110. As illustrated in FIG. 3A, the image forming apparatus 110 has a central processing apparatus (CPU) 301, a read-only memory (ROM) 302, a random-access memory (RAM) 304, a printer device 305, the scanner device 306, a storage 308, an external interface 311, and so on, which are connected to one another through a data bus 303. The CPU 301 is a control unit for comprehensively controlling the operation of the image forming apparatus 110. The CPU 301 boots the system of the image forming apparatus 110 by executing a boot program stored in the ROM 302, and implements functions of the image forming apparatus 110 such as printing, scanning, and faxing by executing a control program stored in the storage 308. The ROM 302 is implemented with a non-volatile memory, and is a storage unit for storing the boot program that boots the image forming apparatus 110. The data bus 303 is a communication unit for performing data communication between constituent devices of the image forming apparatus 110. The RAM 304 is implemented with a volatile memory, and is a storage unit used as a work memory in a case where the CPU 301 executes the control program.

The printer device 305 is an image output device, and prints an image on a print medium, such as paper, and outputs it. The scanner device 306 is an image input device, and is used to optically read a document such as a sheet of paper on which characters, figures, charts, and/or the like are printed, and generate a document image. An original conveyance device 307 is implemented with an auto-document feeder (ADF) or the like, and detects an original placed on platen glass and conveys the detected original to the scanner device 306 sheet by sheet.

The storage 308 is implemented with a hard disk drive (HDD) or the like, and is a storage unit for storing the control program and the document image mentioned above. An input device 309 is implemented with a touch panel, hardware keys, and the like, and receives operation inputs on the image forming apparatus 110 from the user. A display device 310 is implemented with a liquid crystal display or the like, and is a display unit for displaying setting screens of the image forming apparatus 110 to the user. The external interface 311 is for connecting the image forming apparatus 110 to the network 104, and is an interface unit for receiving fax data from a fax transmitter not illustrated and transmitting document images to the information processing apparatus 130, for example.

### [Hardware Configuration of Training Apparatus]

FIG. 3B is a diagram illustrating the hardware configuration of the training apparatus 120. As illustrated in FIG. 3B, the training apparatus 120 has a CPU 331, a ROM 332, a RAM 334, a storage 335, an input device 336, a display device 337, an external interface 338, and a graphics processing unit (GPU) 339, which are connected to one another through a data bus 333.

The CPU 331 is a control unit for comprehensively controlling the operation of the training apparatus 120. The CPU 331 executes a boot program stored in the ROM 332 to boot the system of the training apparatus 120. Also, the CPU 331 executes a training program stored in the storage 308 to perform a layout analysis on document image samples, the generation of the document type estimation model and the item value estimation model, and the like. The ROM 332 is implemented with a non-volatile memory, and is a storage unit for storing the boot program that boots the training apparatus 120. The data bus 333 is a communication unit for performing data communication between constituent devices of the training apparatus 120. The RAM 334 is implemented with a volatile memory, and is a storage unit used as a work memory in a case where the CPU 331 generates document data and execute a training program.

The storage 335 is implemented with an HDD or the like, and is a storage unit for storing data of the document image samples. The input device 336 is implemented with a mouse, a keyboard, and the like, and receives operation inputs on the training apparatus 120 from the engineer. The display device 337 is implemented with a liquid crystal display or the like, and is a display unit for displaying setting screens of the training apparatus 120 to the engineer. The CPU 331 operates a display control unit that controls screens to be displayed on the display device 337.

The external interface 338 is for connecting the training apparatus 120 to the network 104, and is an interface unit for receiving the document image samples 121 from a PC or the like not illustrated. The external interface 338 is also an interface unit for transmitting the document type estimation model and the item value estimation model to the information processing apparatus 130. The GPU 339 is a computation unit including an image processing processor. The GPU 339 executes computation for generating the document type estimation model and the item value estimation model based on data of character strings included in a given document image in accordance with a control command given from the CPU 331, for example.

The CPU 331 implements the functional units included in the training apparatus 120 illustrated in FIG. 1 by executing a predetermined program, but the present embodiment is not limited to this manner. Alternatively, for example, hardware such as the GPU 339, which is for speeding up computation, or a field programmable gate array (FPGA) not illustrated may be utilized. Each functional unit may be implemented by software and hardware, such as a dedicated integrated circuit (IC), cooperating with each other, or some or all of the functions may be implemented solely with hardware.

### [Hardware Configuration of Information Processing Apparatuses]

FIG. 3C is a diagram illustrating the hardware configuration of the information processing apparatus 130. As illustrated in FIG. 3C, the information processing apparatus 130 has a CPU 361, a ROM 362, a RAM 364, a storage 365, an input device 366, a display device 367, and an external interface 368. Each components are connected to one another through a data bus 363.

The CPU 361 is a control unit for comprehensively controlling the operation of the information processing apparatus 130. The CPU 361 executes a boot program stored in the ROM 362 to boot the system of the information processing apparatus 130 and execute an information processing program stored in the storage 365. As a result of executing the information processing program, the information processing unit 131 executes its processing.

The ROM 362 is implemented with a non-volatile memory, and is a storage unit for storing the boot program that boots the information processing apparatus 130. The data bus 363 is a communication unit for performing data communication between constituent devices of the information processing apparatus 130. The RAM 364 is implemented with a volatile memory, and is a storage unit used as a work memory in a case where the CPU 361 executes the information processing program. The storage 365 is implemented with an HDD or the like, and is a storage unit for storing the information processing program, the document image 113, and the item value estimation model mentioned above as well as data of character strings and the like.

The input device 366 is implemented with a mouse, a keyboard, and the like, and is an operation for receiving operation inputs on the information processing apparatus 130 from the user or the engineer. The display device 367 is implemented with a liquid crystal display or the like, and is a display unit for displaying setting screens of the information processing apparatus 130 to the user or the engineer. The CPU 361 operates a display control unit that controls screens to be displayed on the display device 367.

The external interface 368 is for connecting the information processing apparatus 130 to the network 104. Moreover, the external interface 368 is an interface unit for receiving the item value estimation model and the document type estimation model from the training apparatus 120 and the document image 113 from the image forming apparatus 110.

The CPU 361 implements the functional units included in the information processing apparatus 130 in FIG. 1 by executing a predetermined program, but the present embodiment is not limited to this manner. Alternatively, for example, hardware such as a GPU for speeding up computation or an FPGA may be utilized. Each functional unit may be implemented by software and hardware, such as a dedicated IC, cooperating with each other, or some or all of the functions may be implemented solely with hardware.

### [Sequence for Generating Trained Models]

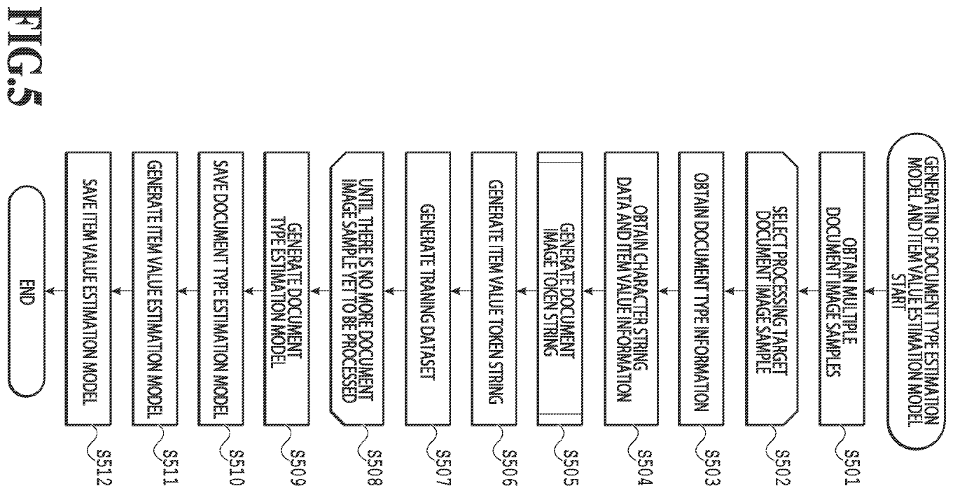

FIGS. 4A and 4B are diagrams illustrating sequences by the information processing system 100 in FIG. 1. The symbol “S” in the description of each process means a step in the sequence. This applies also to the subsequent flowcharts. Also, operations by the user and the engineer are described as steps as well for the sake of description.

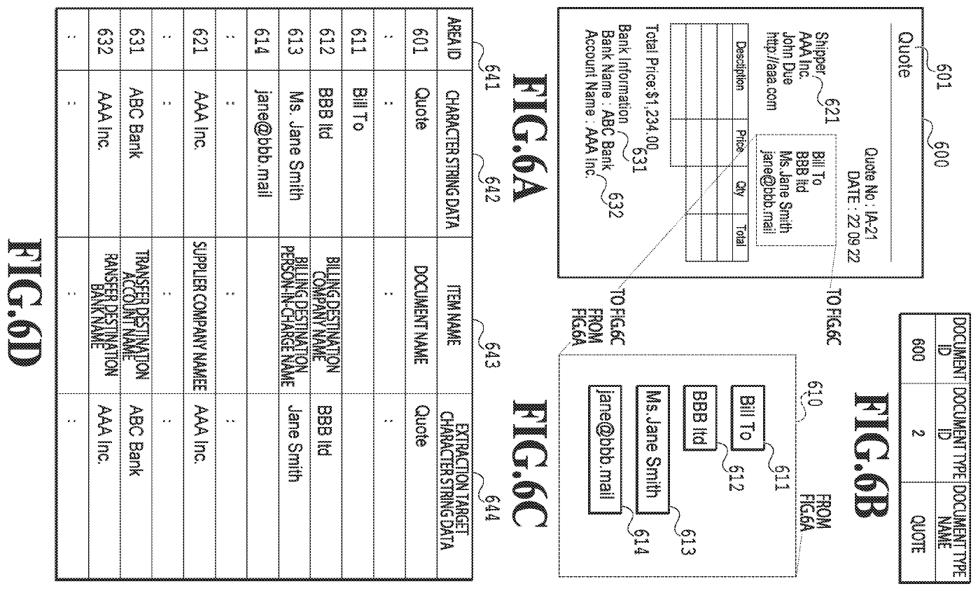

The process in FIG. 4A represents a flow of development of trained models by the engineer, and is a diagram describing a flow of generating the document type estimation model and the item value estimation model by the training apparatus 120. Details of S402 to S405 in FIG. 4A will be described later using FIG. 5.

In S401, an engineer 400 of the information processing system 100 inputs the multiple document image samples 121, which are samples of images representing multiple documents, into the training apparatus 120 in order to generate the document type estimation model and the item value estimation model. Each document image sample has been given document type information indicating the document type by the engineer. Each document image sample has also been given information on item names to be learned by the item value estimation model and the character strings of those item names by the engineer in advance.

In S402, the training apparatus 120 generates training data by using the multiple document image samples 121 and the document types of the multiple document image samples 121. Then, the training apparatus 120 performs training using the training data to generate the document type estimation model. As a result, the document type estimation model for estimating document types such as an invoice, a quote, a purchase order, and a delivery note is generated.

In S403, the training apparatus 120 transmits the generated document type estimation model to the information processing apparatus 130. The information processing apparatus 130 saves the document type estimation model in the storage 365.

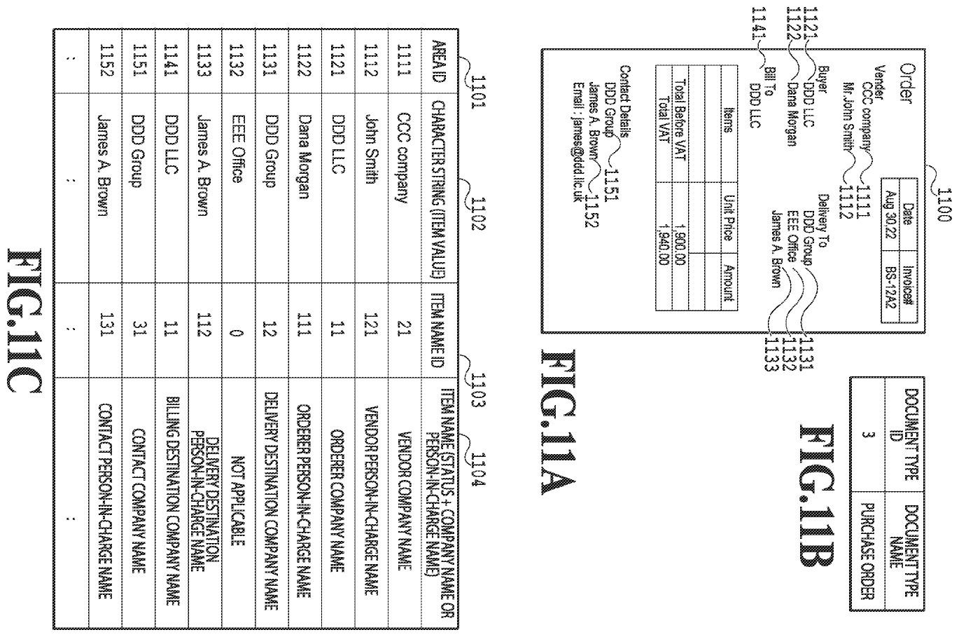

In S404, the training apparatus 120 generates training data by using the multiple document image samples 121, an item name ID list 900 (see FIG. 9), and the like. Then, the training apparatus 120 performs training using the training data to generate the item value estimation model. As a result, the item value estimation model for determining character strings (item values) corresponding to item names representing candidate character strings for issuance source company names (person-in-charge names) and issuance destination company names (person-in-charge names), which are extraction target items in the present embodiment, is generated. Specifically, the extraction target items are items associated with item names determined based on the item value estimation model.

In S405, the training apparatus 120 transmits the generated item value estimation model to the information processing apparatus 130. The information processing apparatus 130 saves the item value estimation model in the storage 365.

In S406, the engineer 400 registers the extraction target character string determination algorithm, in which information such as determination conditions necessary for determining extraction target character strings has been set, to the information processing apparatus 130.

### [Sequence of Process of Determining Extraction Target Character Strings]

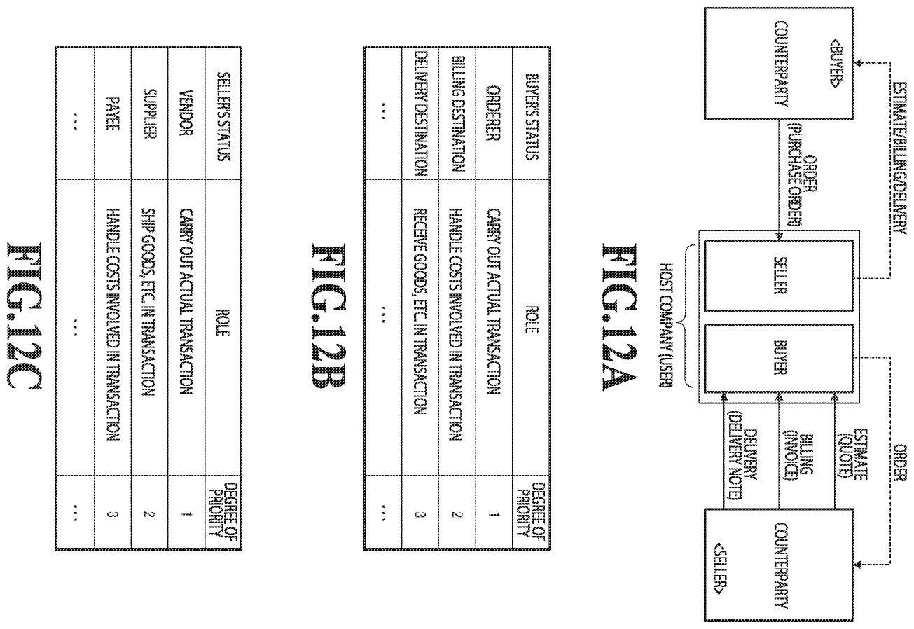

FIG. 4B is a diagram describing a flow of determining the character strings in the document image 113 indicating the issuance source company name (person-in-charge name) and the issuance destination company name (person-in-charge name), which are the extraction target character strings, from among the character strings included in the document image 113 by the information processing apparatus 130. Details of S413 to S417 in FIG. 4B will be described using FIG. 10.

In S411, a user 401 sets a paper document (original) on the image forming apparatus 110 and instructs the image forming apparatus 110 to scan the document.

In S412, the scanner device 306 of the image forming apparatus 110 reads the set paper document, and the image obtaining unit 118 generates a document image being an image of the scanned document. The image obtaining unit 118 then transmits the generated document image to the information processing apparatus 130.

In S413, the information processing apparatus 130 executes a character recognition process (optical character recognition (OCR) process) on the document image 113 transmitted in S412 and also a layout analysis process which analyzes the layout of the document image.

In S414, the information processing apparatus 130 determines the document type of the document image 113 by using the document type estimation model.

In S415, the information processing apparatus 130 determines candidate character strings (item values) for the extraction target character strings from among the character strings recognized in the document image 113 by using the item value estimation model.

In S416, the information processing apparatus 130 applies the document type determined in S414 and the item values determined in S415 to the extraction target character string determination algorithm registered in S406 to determine the extraction target character strings.

In S417, the information processing apparatus 130 outputs the extraction target character strings determined in S416 to the user.

### [Process of Generating Document Type Estimation Model and Item Value Estimation Model]

FIG. 5 is a flowchart describing details of S402 to S405 in FIG. 4A executed by the training apparatus 120. At least one of the CPU 331 and the GPU 339 of the training apparatus 120 performs the series of processes illustrated in the flowchart of FIG. 5 by loading program code stored in the ROM 332 or the storage 335 to the RAM 334 and executing it. Alternatively, the functions of some or all of the steps in FIG. 5 may be implemented with hardware such as an application-specific integrated circuit (ASIC) or an electronic circuit.

In S501, the training data generation unit 122 obtains the multiple document images input by the engineer in S401 in FIG. 4 as the multiple document image samples 121. The following description will be given on the assumption that images of documents handled in office accounting work are obtained as the document image samples 121.

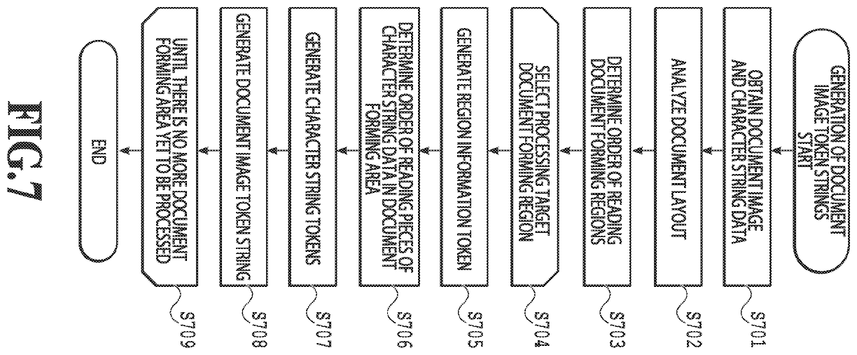

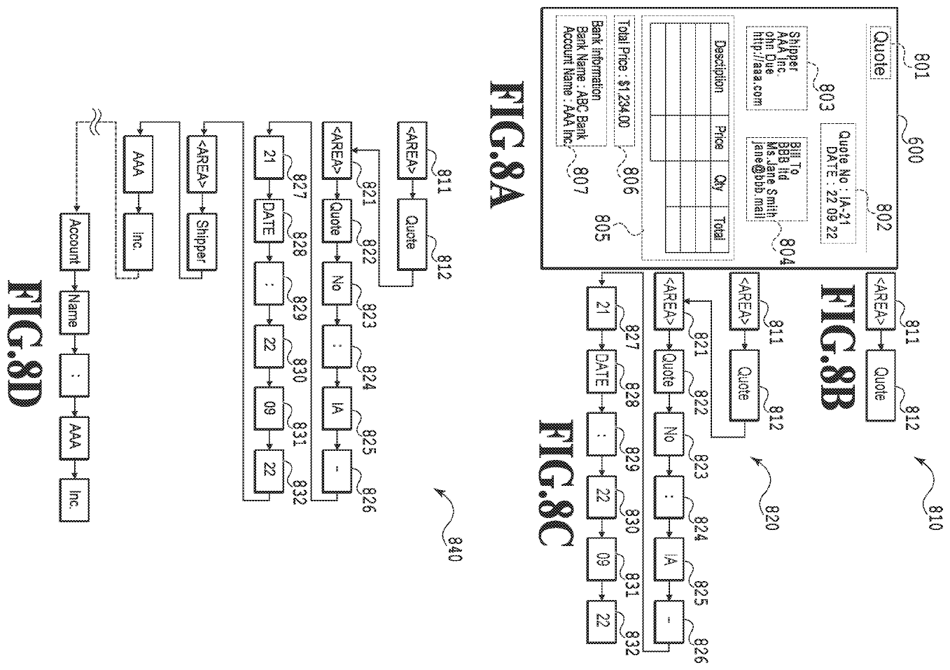

A document image 600 in FIG. 6A is an example of the document image samples obtained in S501 and represents a document image obtained by scanning a quote.

Next S502 to S508 are a loop process. The processes of S502 to S508 are repeated for each of the multiple document image samples obtained in S501.

Specifically, in S502, the training data generation unit 122 selects a processing target document image sample from among document image samples yet to be processed among the multiple document image samples obtained in S501. The processing target document image sample is subjected to the processes of S503 to S507. After the processes for the processing target document image sample are finished, it is determined in S508 whether all of the multiple document image samples have been processed. If it is determined that not all of the document image samples have been processed, the processing returns S502, and a processing target document image sample is selected again from among the document image samples yet to be processed.

In S503, the training data generation unit 122 obtains information on the document type of the processing target document image sample (document type information). The document type information is information indicating the document type and contains, for example, a document type name being the name of the document type and a document type ID being a unique value allocated to the document type name. In S401 in FIG. 4, the multiple document image samples are each given document type information by the engineer 400. Thus, the training data generation unit 122 can obtain the document type information corresponding to the processing target document image sample.

FIG. 6B is a diagram illustrating an example of the document type information. FIG. 6B is an example of the document type information corresponding to the document image 600 illustrated in FIG. 6A. As illustrated in FIG. 6B, a document type ID “2” and a document type name “quote” are obtained as the document type information, for example.

In S504, the training data generation unit 122 obtains data of the character strings included in the processing target document image sample and obtains the name of the item represented by each character string (item name). These pieces of information are obtained based on information given to the processing target document image sample by the engineer 400.

FIG. 6C is an enlarged view a dotted-line area 610 in the document image 600. The area 610 includes character string areas 611 to 614. In S504, obtained are the character strings recognized in the character string areas in the processing target document image sample. Each character string area is given an area ID being a unique value for identifying the character string area.

FIG. 6D is a diagram of the pieces of information obtained in S504 organized in the form of a table. A column 641 in FIG. 6D holds values indicating area IDs. A column 642 holds character strings contained in the character string areas indicated by the area IDs. A column 643 holds item names corresponding to the character strings held in the column 642. A column 644 holds character strings to be extracted among the character strings held in the column 642. The item names in the column 643 and the extraction target character strings in the column 644 will be referred to as “item value information”. Thus, the character strings recognized from the document image sample, and the item value information corresponding to the recognized character strings are obtained.

For example, in FIG. 6D, a row (record) holding an area ID “613” in the column 641 holds a character string “Ms. Jane Smith” in the column 642. Moreover, this record holds an item name “billing destination person-in-charge name” in the column 643 and extraction target character string data “Jane Smith” in the column 644. Thus, obtained is information in which the character string “Ms. Jane Smith” in the document image sample and the item name “billing destination person-in-charge name” are associated with each other.

Likewise, as indicated by the record holding an area ID “621”, an item name “supplier company name” is associated with a character string “AAA Inc.” In the record holding an area ID “631”, an item name “transfer destination bank name” is associated with a character string “ABC Bank”. In the record holding an area ID “632”, an item name “transfer destination account name” is associated with a character string “AAA Inc.” The record holding an area ID “611” does not contain a character string indicating an item name in the column 643. In such a case, the character string “Bill To” will be obtained as the item value information.

In S505, the training data generation unit 122 generates a document image token string corresponding to the processing target document image sample. The information processing unit 131 of the information processing apparatus 130 may execute the process of generating the document image token string in S505.

FIG. 7 is a flowchart for describing details of the process of generating the document image token string. Details of the process of S505 will now be described with reference to FIG. 7.

In S701, the training data generation unit 122 obtains image data of the processing target document image and data of the character strings included in the document image. In the process of generating the document image token string in S505, the training data generation unit 122 obtains image data of the processing target document image sample and data of the character strings recognized in the processing target document image sample.

In S702, the training data generation unit 122 analyzes the layout of the processing target document image obtained in S701. Through the analysis, the training data generation unit 122 identifies document forming areas in the document image, and extracts the identified document forming areas. In one method of extracting the document forming areas, blank areas, ruled lines, and the like in the document image may be identified, and the areas surrounded by the identified blank areas, ruled lines, and the like may be identified as the document forming areas.

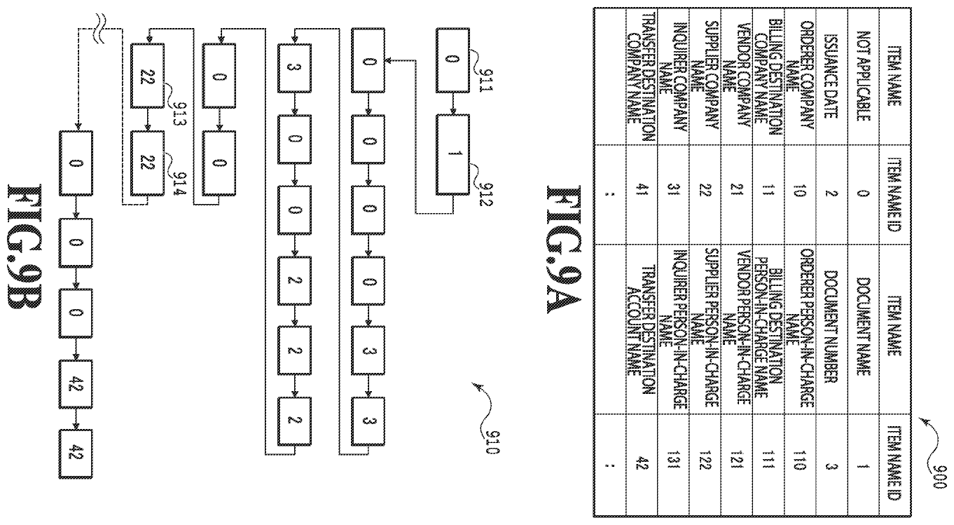

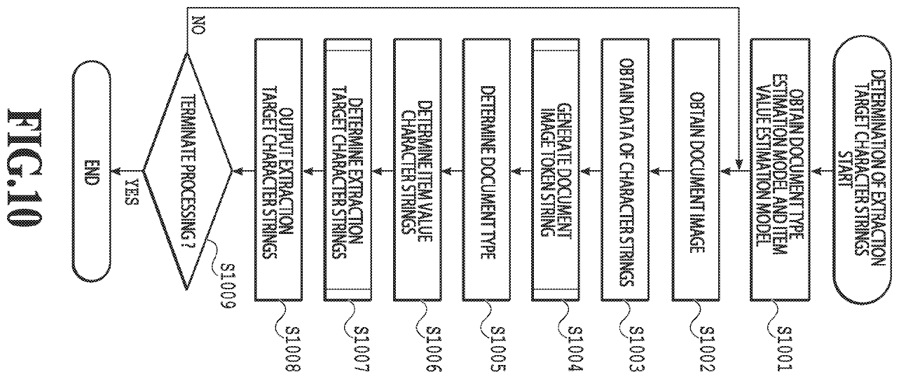

FIGS. 8A to 8D are diagrams for describing a process of generating a document image token string from the document image 600 in FIG. 6A. The dotted-line rectangular areas in FIG. 8A are document forming areas 801 to 807 extracted as a result of the layout analysis on the processing target document image 600.

In S703, the training data generation unit 122 determines the order of reading the document forming areas extracted in S702 (reading order). For example, the training data generation unit 122 may determine the reading order with an upper left portion of the document image 600 as a starting point such that the document forming areas 801 to 807 will be read in this order.

Next S704 to S709 are a loop process. In S704, the training data generation unit 122 selects a processing target from among the document forming areas extracted in S702 by following the reading order determined in S703. For example, in a case where the document forming areas 801 to 807 have been identified as illustrated FIG. 8A, the training data generation unit 122 sequentially selects them starting from the document forming area 801 as the processing target. The processing target document forming area will be subjected to the processes of S705 to S708. After the processes for the processing target document forming area are finished, it is determined in S709 whether all of the document forming areas have been processed. If it is determined that not all of the document forming areas have been processed, the processing returns to S704, and the next document forming area is selected as a processing target.

In S705, the training data generation unit 122 converts information on the processing target document forming area into an area information token “<AREA>”. This can be indicated as the document forming area boundary in a document image token string to be generated.

In S706, in a case where multiple character strings are present in the processing target document forming area, the training data generation unit 122 determines the order of reading the character strings. For example, in a case where the processing target forming area contains multiple character strings like the document forming area 803, the training data generation unit 122 may determine the order of reading the character strings so as to sequentially read the character strings from an upper left portion of the document forming area 803.

In S707, the training data generation unit 122 arranges the character strings contained in the processing target document forming area in the reading order determined in S706 and converts the arranged character strings into character string tokens. The conversion into character string tokens may be done by a method in which morphemes are extracted from the character strings by using a morpheme analysis technique and each individual morpheme is defined as a character string token.

Character string tokens 822 to 832 in FIG. 8C are character string tokens converted from the character strings in the document forming area 802.

In S708, the training data generation unit 122 joins the area information token obtained in S705 and the character string tokens obtained in S707 with the area information token at the head to generate a document image token string of the processing target document forming area. In a case where a document image token string has already been generated, the training data generation unit 122 joins the document image token string generated from the processing target document forming area to the generated document image token string.

A document image token string 810 in FIG. 8B is a document image token string obtained as a result of the processes of S705 to S708 on the document forming area 801, which is read first. Since the document forming area 801 contains a character string “Quote”, the document image token string 810 is a token string in which an area information token 811 and then a character string token 812 generated from “Quote” are joined.

A document image token string 820 in FIG. 8C is a document image token string obtained as a result of the processes of S705 to S708 on the document forming area 802, which is read second. A document image token string in which an area information token 821 and the character string tokens 822 to 832 converted from the character strings in the document forming area 802 are joined is joined to the end of the already generated document image token string 810 to thereby generate the document image token string 820.

If it is determined in S709 that there is no document forming area yet to be processed, the flowchart of FIG. 7 ends, so that the process of generating a document image token string for the processing target document image is terminated.

FIG. 8D illustrates a document image token string 840 generated as a result of performing the processes of S705 to S708 on all of the document forming areas 801 to 807 in FIG. 8A. Each rectangle forming the document image token string will be referred to as “token”.

Referring back to FIG. 5, the description of the flowchart will now be resumed. In S506, the training data generation unit 122 generates an item value token string corresponding to the processing target document image sample. The item value token string is generated from the document image token string 840 generated in S505.

FIGS. 9A and 9B are diagrams for describing the process of generating the item value token string. FIG. 9A is a diagram illustrating an example of an item name ID list used to generate the item value token string. In the item name ID list 900, character strings indicating item names and item name IDs being unique values for identifying the respective item names are held in association with each other. The item value token string is generated by converting the character string contained in each token forming the document image token string into the value of the corresponding item name ID by using the item name ID list 900.

FIG. 9B is a diagram illustrating an item value token string 910 generated from the document image token string 840 in FIG. 8D. For example, the item name ID list 900 is searched to determine whether the item name indicated by the character string corresponding to “<AREA>” contained in the area information token 811 in the document image token string 840 in FIG. 8D is held as an item name in the item name ID list 900. Since “<AREA>” is not a character string representing an item name, “<AREA>” contained in the area information token 811 is replaced with an item name ID “0” associated with “not applicable” in the item name ID list 900. A token 911 is a token replaced with the area information token 811.

Likewise, “Quote” contained in the character string token 812 in the document image token string 840 is a character string representing an item name “document name”, as indicated in the column 643 in the record in FIG. 6D holding an area ID “601”. In the item name ID list 900, “1” is held as the item name ID corresponding to the item name “document name”. Thus, the character string token 812 in the document image token string 840 is replaced with a token 912 containing the item name ID “1”. A similar process is performed on all of the tokens forming the document image token string 840. As a result, the item value token string 910 illustrated in FIG. 9B is generated.

Note that the item name IDs are not limited to the values held in the item name ID list 900 in FIG. 9A. The item names corresponding to item name IDs to be estimated by the item value estimation model are held as item names to be included in the item name ID list 900. However, in the present embodiment, the item names “issuance destination” and “issuance source” are not included in the item name ID list 900. This is because generating an item value estimation model capable of estimating “issuance destination” and “issuance source” will increase the burden of the generation, as mentioned earlier.

Also, how to give item name IDs is not limited to the method described above. For example, item value tokens may be generated as item name IDs by using the inside-outside-beginning (IOB) format or the beginning-inside-last-outside-unit (BILOU) format. In the case of the IOB format, “B-” (Beginning) may be given to a starting item value token, and “I-” (Inside) may be given to intermediate item value tokens. In the case of the BILOU format, “L-” (Last) may be given to an ending item value token, and “U-” (Unit) may be given to single item value tokens, in addition to the prefixes in the IOB format. Processing as above makes it possible to perform training and inference while clarifying the range of character strings to be extracted.

Referring back to FIG. 5, the description of the process will now be resumed. In S507, the training data generation unit 122 generates a training dataset for training the document type estimation model. The training data generation unit 122 also generates a training dataset for training the item value estimation model.

The training dataset for training the document type estimation model is, for example, data for performing supervised learning and is a dataset in which the document image token string 840 generated in S505 serves as input data and the document type ID obtained in S503 serves as supervisory data.

The training dataset for training the item value estimation model is, for example, a dataset in which the document image token string 840 generated in S505 serves as input data and the item value token string 910 generated in S505 serves as supervisory data.

By performing S503 to S507, training datasets for training the document type estimation model and the item value estimation model are generated from the processing target document image sample. By repeating the processes of S503 to S507 until there is no more document image sample yet to be processed, multiple sets of training datasets are obtained which are generated from the multiple document image samples obtained in S501. If determining in S508 that all of the document image samples have been processed, the training data generation unit 122 advances the processing to S509.

In S509, the training unit 123 generates the document type estimation model by machine learning using the generated training datasets. The document type estimation model is, for example, a trained model trained to estimate and output a document type ID corresponding to the document type of a document represented by a document image in response to input of a document image token string generated from that document image.

In S510, the training unit 123 transmits the document type estimation model generated in S509 to the information processing apparatus 130. The document type estimation model is then saved in the storage 365 in the information processing apparatus 130.

In S511, the training unit 123 generates the item value estimation model by machine learning using the generated training datasets. The item value estimation model is, for example, a trained model trained to estimate and output an item value token string having a similar structure to FIG. 9B in response to input of a document image token string generated from a document image.

In S512, the training unit 123 transmits the item value estimation model generated in S511 to the information processing apparatus 130. The item value estimation model is then saved in the storage 365 in the information processing apparatus 130.

In the processes of S509 and S511, the models can learn not only the relationship between each extraction target character string token and the preceding and following character string tokens but also the relationship between the character string tokens in the same area and the relationship between the character string tokens in separate areas. Specifically, the models can learn, for example, a tendency that character strings serving as a key to finding an extraction target character string (keywords corresponding to an item name) are likely to appear in the same area and not likely to appear in separate areas.

Incidentally, publicly known machine learning techniques may be used for the training of the document type estimation model and the item value estimation model. For example, it is possible to use a recurrent neural network (RNN), Seq2Seq, Transformer, Bidirectional Encoder Representations from Transformers (BERT), and the like used in natural language machine translation, document classification, named entity extraction, and the like.

Also, the document type estimation model and the item value estimation model have been described as being generated as independent trained models. Alternatively, a model can be trained so as to be generated as a single trained model that simultaneously performs document type estimation and item value estimation.

### [Process of Determining Extraction Target Character Strings]

FIG. 10 is a flowchart describing details of the process of determining extraction target character strings performed in S413 to S417 in FIG. 4B. The CPU 361 of the information processing apparatus 130 performs the series of processes illustrated in the flowchart of FIG. 10 by loading program code stored in the ROM 362 or the storage 365 to the RAM 364 and executing it. Alternatively, the functions of some or all of the steps in FIG. 10 may be implemented with hardware such as an ASIC or an electronic circuit. As mentioned earlier, in the present embodiment, a process of determining character strings indicating an issuance destination and an issuance source as extraction target character strings from a document image is performed.

In S1001, the information processing unit 131 obtains the document type estimation model transmitted from the training apparatus 120 and saved in the storage 365 in S403 in FIG. 4. The information processing unit 131 also obtains the item value estimation model transmitted from the training apparatus 120 and saved in the storage 365 in S405 in FIG. 4.

In S1002, the information processing unit 131 obtains the document image transmitted from the image forming apparatus 110 in S412 in FIG. 4.

In S1003, the information processing unit 131 extracts the character string areas included the document image obtained in S1002. The information processing unit 131 then executes a character recognition process (OCR process) on the extracted character string areas to obtain data of the character strings included in the document image (character string data).

In S1004, the information processing unit 131 generates a document image token string for the document image obtained in S1002 based on the document image obtained in S1002 and the character string data obtained in S1003. Details of the process of generating the document image token string are performed by following the flow illustrated in FIG. 7. Details of S1004 are the same as the description of FIG. 7 with the training data generation unit 122 replaced with the information processing unit 131, and description thereof is therefore omitted.

In S1005, the information processing unit 131 inputs the document image token string generated in S1004 into the document type estimation model obtained in S1001 to obtain a document type ID based on the result of the estimation. The information processing unit 131 causes the document type estimation model to perform an inference process as described above to determine the document type of the document image obtained in S1002.

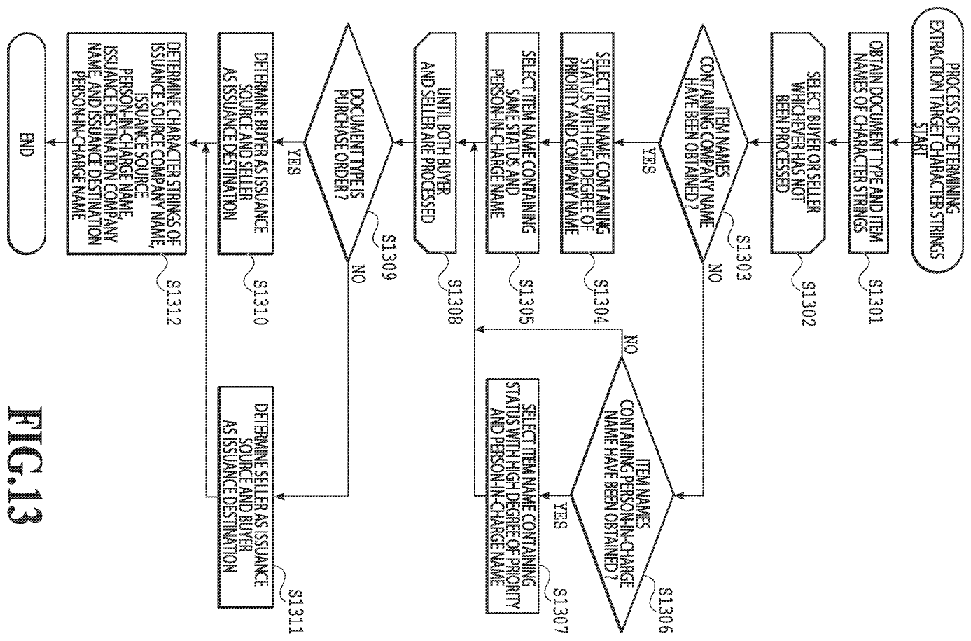

FIGS. 11A to 11C are diagrams for describing the process of determining the extraction target character strings. FIG. 11A is an example of the document image obtained in S1002. FIG. 11B indicates that the document type ID has been determined to be “3” as a result of inputting a document image token string generated from a document image 1100 in FIG. 11A into the document type estimation model. FIG. 11B also indicates that the document type name corresponding to the document type ID “3” is “purchase order”.

Incidentally, the document type estimation model may output probability values indicating the degrees of likelihood of being document types corresponding to multiple document type IDs as the inference result. In this case, the information processing unit 131 may determine the document type indicated by the document type ID with the highest probability value as the document type of the processing target document image.

In S1006, the information processing unit 131 inputs the document image token string into the item value estimation model obtained in S1001. The item value estimation model outputs an item value token string having a similar structure to FIG. 9B as the result of the estimation.

The inference process performed by the item value estimation model estimates which item name ID in the item name ID list 900 each individual character string token included in the document image token string corresponds to, based on the relationship between the character string tokens and the area information tokens used in the training. Incidentally, the item value estimation model may output probability values indicating the degrees of likelihood of being the item names corresponding to item name IDs for each individual character string token. In this case, the information processing unit 131 may determine the item name represented by the item name ID with the highest probability value as the item name of the character string represented by the character string token.

Then, based on the item value token string output from the item value estimation model, the information processing unit 131 determines the character strings (item values) corresponding to the item names from the character strings recognized in S1003, and determines the item names corresponding to those item values.

For example, the information processing unit 131 searches for tokens containing numeric values other than “0”, which indicates “not applicable”, in the output item value token string. Each token in the item value token string output from the item value estimation model can be associated with a token in the document image token string input into the item value estimation model. Thus, the information processing unit 131 identifies the tokens in the document image token string corresponding to the searched tokens. Based on that result, the information processing unit 131 converts the output item value token string into character strings. Assume, for example, that the item value token string output from the item value estimation model is the item value token string 910 in FIG. 9B. In a case of searching for “22” for tokens 913 and 914, tokens “AAA” and “Inc.” at the same position in the input data are obtained, and these tokens are combined into a character string “AAA Inc.” and determined as an item value. As a result, the item name ID “22” and the character string “AAA Inc.”, which is the item value, are associated with each other.

FIG. 11C is a diagram of the result of the process of S1006 organized in the form of a table. In FIG. 11C, the character strings determined as item values and the item names of the character strings determined as item values are associated with each other. For example, “CCC company” recognized from an area ID “1111” indicates that it is determined as a character string with an item value corresponding to an item name “vendor company name” with an item name ID “21”. The item values determined in S1006 will be used as candidate character strings for the extraction target character strings in the present embodiment.

In S1007, the information processing unit 131 determines the extraction target character strings from among the item values (character strings) corresponding to the item names obtained in S1006. Specifically, the extraction target character strings in the present embodiment are a character string indicating the company name of the issuance destination of the document, a character string indicating the name of the person in charge at the issuance destination, a character string indicating the company name of the issuance source, and a character string indicating the name of the person in charge at the issuance source. In the present embodiment, the extraction target character strings are determined by applying the document type determined in S1005 and the item values determined in S1006 to the extraction target character string determination algorithm. Details of the process of S1007 will be described later.

In S1008, the information processing unit 131 performs a process of outputting and presenting the extraction target character strings determined in S1007 to the user.

In S1009, the information processing unit 131 determines whether to terminate the processing, and repeats the processes of S1002 to S1008 until receiving a notification to terminate the processing from the user.

### [Extraction Target Character String Determination Algorithm]

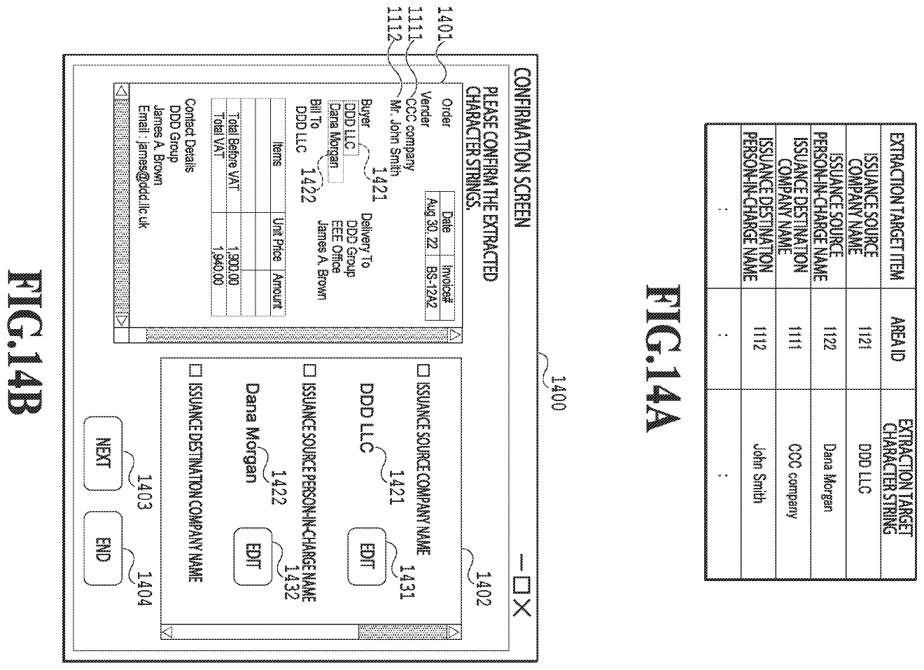

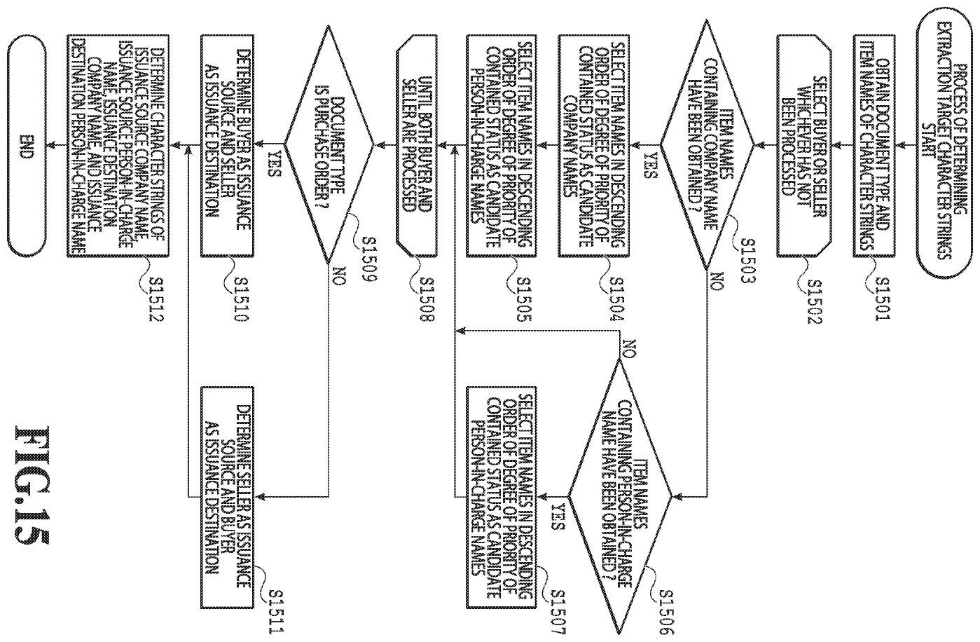

FIGS. 12A to 12C are diagrams for describing the process of determining the extraction target character strings. To determine the extraction target character strings, the relationship between the company names or the person-in-charge names written in the document is defined.

As illustrated in FIG. 12A, in a case of selling goods, the company who is the user (host company) can be the seller or the buyer. In the case where the user is the buyer, then, in response to performing a process of purchasing goods, the user receives a quote describing an estimated price, an invoice describing the billing amount, the transfer destination, and the like, and a delivery note describing information on the contents to be delivered from the counterparty being the issuance source of these documents. On the other hand, in the case where the user is the seller, the counterparty places an order, and the user in turn receives a purchase order describing information on the goods which the counterparty desires to purchase and the like from the counterparty, or the issuance source of the purchase order. Thus, the user can be the buyer or the seller depending on the content of the transaction.

FIG. 12B is a table in which possible statuses of the user in the case where the user is the buyer, the roles of these statuses, and the ranks of the degrees of priority corresponding to the degrees of importance of the roles of the statuses are associated with one another. Possible examples of the statuses of the buyer include statuses such as the orderer, the billing destination, and the delivery destination. Among these statuses, one that is important in making a transaction is the orderer, who actually carries out the process. In FIGS. 12B and 12C, the degrees of priority are held such that the smaller the value, the higher the rank. Thus, in the case where the status is an orderer, the associated degree of priority is higher (the value is smaller) than those of the other statuses.

FIG. 12C is a table in which possible statuses of the user in the case where the user is the seller, the roles of these statuses, and the degrees of priority corresponding to the degrees of importance of the roles of the statuses are associated with one another. Among the seller's statuses, one that is important in making a transaction is the vendor, who actually carries out the process. Thus, in the case where the status is a vendor, the associated degree of priority is higher than those of the other statuses.

The character strings indicating the statuses held in the tables in FIGS. 12B and 12C (e.g., “billing destination”) are used as character strings forming the item names in FIG. 9A. As illustrated in the item name ID list 900 in FIG. 9A, these include item names containing a combination of a character string indicating the seller's or buyer's status (e.g., billing destination”) and a character string “company name” or “person-in-charge name” (e.g., “billing destination company name”). The reason for using such item names will be described later.

The statuses, roles, and degrees of priority illustrated in FIGS. 12B and 12C are an example. Though not illustrated, various other statuses, such as “contact”, may be included. Also, company information not to be handled as an extraction target may be set.

FIG. 13 is a flowchart for describing the extraction target character string determination algorithm. Details of the process of S1007 in FIG. 10 will now be described with reference to FIG. 13.

In S1301, the information processing unit 131 obtains the document type determined in S1005 and the item values (character strings) and the item names determined in S1006. For example, the information processing unit 131 obtains the information illustrated in FIG. 11B, which contains the document type, and the information illustrated in FIG. 11C, in which the extracted item values and the corresponding item names are associated with each other.

Next S1302 to S1308 are a loop process. In S1302, the information processing unit 131 selects the buyer or the seller as a processing target. For example, the information processing unit 131 selects the buyer first. Then, the processes of S1303 to S1307 are performed for the buyer as the processing target.

In S1303, the information processing unit 131 determines whether item values corresponding to item names each containing the processing target's (e.g., the buyer's) status and “company name” have been extracted in the determination process of S1006.

If determining that such item values have been extracted (YES in S1303), the information processing unit 131 proceeds to S1304.

For example, in FIG. 12B, character strings “orderer”, “billing destination”, and “delivery destination” are held as the buyer's statuses. Thus, the information processing unit 131 may determine whether item values corresponding to item names each containing one of those character strings and “company name”, namely “orderer company name”, “billing destination company name”, “delivery destination company name”, have been extracted from the document image in S1006.

For example, a column 1104 in FIG. 11C contains “orderer company name”, “delivery destination company name”, and “billing destination company name” as the item names corresponding to item values extracted from the document image. This means that the item values corresponding to item names each containing a status of the buyer, which is the processing target, and “company name”, namely “orderer company name”, “billing destination company name”, and “delivery destination company name”, have been extracted. Thus, if FIG. 11C has been obtained as a result of the process of S1006, the information processing unit 131 determines YES in S1303 and proceeds to S1304.

As described above, in the present embodiment, the item value estimation model has been trained to estimate item values corresponding to item names each containing the buyer's status or the seller's status. Thus, by checking the item names determined using the item value estimation model, the information processing unit 131 can determine whether the document image includes character strings indicating the buyer and character strings indicating the seller.

In S1304, from among the item values corresponding to the item names each containing the processing target's status and “company name”, the information processing unit 131 selects the item value corresponding to the item name containing the status with the highest degree of priority and “company name” as “buyer company name” to be output.

For example, in FIG. 12B, in the case where the processing target is the buyer, the status with the highest degree of priority is “orderer”. Thus, in a case where the column 1104 in FIG. 11C, which holds item names, includes “orderer company name”, the information processing unit 131 selects the character string in the column 1102 holding the item value corresponding to that item name. In a case where the item value corresponding to the item name “orderer company name” has not been extracted, the information processing unit 131 selects the item value corresponding to the item name with the second highest degree of priority, which is “billing destination company name”.

In FIG. 11C, the record with an area ID “1121” holds an item value “DDD LLC” with the item name “orderer company name”. Thus, “DDD LLC” is selected as the buyer company name to be output. In the case where the processing target is the seller, the status with the highest degree of priority is “vendor”. In FIG. 11C, the record with the area ID “1111” holds the item value “CCC Company” of an item name “vendor company name”. Thus, “CCC Company” is selected as the seller company name to be output.

In S1305, the information processing unit 131 selects the item value corresponding to an item name containing the status contained in the item name selected in S1304 and “person-in-charge name” from among the item values extracted in S1006. The selected item value is set as the buyer person-in-charge name to be output. For example, in a case where the item value corresponding to “orderer company name” is selected in S1304, then, in S1305, the item value corresponding to an item name “orderer person-in-charge name” is selected.

In FIG. 11C, the record with an area ID “1122” holds an item value “Dana Morgan” corresponding to the item name “orderer person-in-charge name”. Thus, “Dana Morgan” is selected as the buyer person-in-charge name to be output. If the extracted item values do not include a person-in-charge name with the same status, it is determined that there is no corresponding person-in-charge name.

Also, in the case where the processing target is the seller, “John Smith” is selected as the seller person-in-charge name to be output since the record with an area ID “1112” holds an item value “John Smith” corresponding to an item name “vendor person-in-charge name”.

On the other hand, if determining in S1303 that no item value has been extracted which corresponds to an item name containing the processing target's status and “company name” (NO in S1303), the information processing unit 131 proceeds to S1306.

In S1306, the information processing unit 131 performs a process in which “company name” in S1303 is replaced with “person-in-charge name”. Specifically, the information processing unit 131 determines whether item values corresponding to item names each containing a character string indicating the processing target's status and “person-in-charge name” have been extracted in the process of S1006. For example, in the case where the processing target is the buyer, the information processing unit 131 may determine whether item values corresponding to item names “orderer person-in-charge name”, “billing destination person-in-charge name”, and “delivery destination person-in-charge name” have been extracted based on the extracted item values in FIG. 11C.

If determining that such item values have been extracted (YES in S1306), the information processing unit 131 proceeds to S1307. If determining that such item values have not been extracted (NO in S1306), the information processing unit 131 proceeds to S1308.

In S1307, the information processing unit 131 performs a process in which “company name” in S1304 is replaced with “person-in-charge name”. Specifically, from among the item values corresponding to the item names each containing a character string indicating the processing target's status and “person-in-charge name”, the information processing unit 131 selects the item value corresponding to the item name containing the status with the highest degree of priority as the output target. As illustrated in FIG. 12B, the buyer's status with the highest degree of priority is “orderer”. Thus, in the case where the processing target is the buyer, then, if the item name “orderer person-in-charge name” is present in FIG. 11C, the item value corresponding to that item name will be selected. If the item name “orderer person-in-charge name” is not present, the item value corresponding to the item name “billing destination person-in-charge name”, which has the second highest degree of priority, will be selected.

In S1308, the information processing unit 131 determines whether the seller and the buyer have both been processed. If determining in S1308 that the buyer and the seller have both been processed, the information processing unit 131 proceeds to S1309.

In S1309, the information processing unit 131 determines whether the document type obtained in S1301 is a purchase order. If determining that the document type is a purchase order (YES in S1309), the information processing unit 131 advances the processing to S1310.

In S1310, the information processing unit 131 determines that the buyer is the issuance source of the document and the seller is the issuance destination of the document, and advances the processing to S1312. In the case of a purchase order, the information processing unit 131 can determine that the buyer is the issuance source of the document since the buyer and the issuance source are associated in advance based on the relationship in FIG. 12A.

If moving from S1310 to S1312, the information processing unit 131 sets the character string corresponding to the buyer company name selected as a result of S1302 to S1308 as a character string corresponding to the issuance source company name. Moreover, the information processing unit 131 sets the character string corresponding to the buyer person-in-charge name as a character string corresponding to the issuance source person-in-charge name. Furthermore, the information processing unit 131 sets the character string corresponding to the seller company name as a character string corresponding to the issuance destination company name and sets the character string corresponding to the seller person-in-charge name as a character string corresponding to the issuance destination person-in-charge name. The information processing unit 131 then terminates the processing in the flowchart of FIG. 13 and moves to S1008 in FIG. 10.

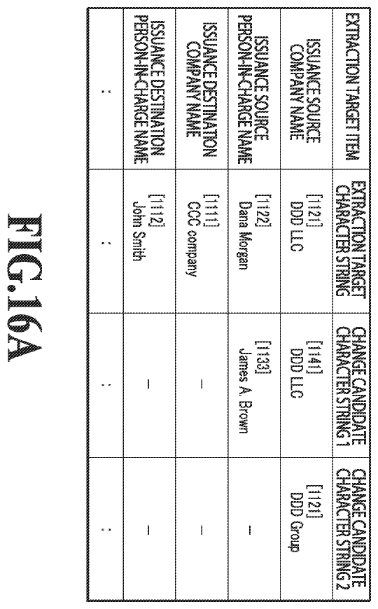

FIGS. 14A to 14C are diagrams for describing the process of determining extraction target character strings. FIG. 14A is a diagram illustrating a list of extraction target character strings determined from among the item values in the document image of the purchase order illustrated in FIG. 11C.

As illustrated in FIG. 14A, in the case where the document image is an image of a purchase order, the character string corresponding to the issuance source company name is determined to be “DDD LLC” selected as the character string to be output as the buyer company name. The character string corresponding to the issuance source person-in-charge name is determined to be “Dana Morgan” selected as the buyer person-in-charge name. The character string corresponding to the issuance destination company name is determined to be “CCC company” selected as the seller company name. The character string corresponding to the issuance destination person-in-charge name is determined to be “John Smith” selected as the seller person-in-charge name.

If, on the other hand, determining that the document type is other than a purchase order (NO in S1309), the information processing unit 131 advances the processing to S1311.

In S1311, the information processing unit 131 determines that the seller is the issuance source of the document and the buyer is the issuance destination of the document, and advances the processing to S1312. In the case of a document type other than a purchase order such as a quote, an invoice, or a delivery note, the seller and the issuance source are associated based on the relationship in FIG. 12A. Thus, the information processing unit 131 can determine that the seller is the issuance source of the document.

If moving from S1311 to S1312, the information processing unit 131 sets the character string corresponding to the buyer company name selected as a result of S1302 to S1308 as a character string corresponding to the issuance destination company name.

Moreover, the information processing unit 131 sets the character string corresponding to the buyer person-in-charge name as a character string corresponding to the issuance destination person-in-charge name. Furthermore, the information processing unit 131 sets the character string corresponding to the seller company name as a character string corresponding to the issuance source company name and sets the character string corresponding to the seller person-in-charge name as a character string corresponding to the issuance source person-in-charge name. The information processing unit 131 then terminates the processing in the flowchart of FIG. 13 and moves to S1008 in FIG. 10.

FIG. 14B illustrates an example of a confirmation screen for the extraction target character strings displayed on the display device 367 of the information processing apparatus 130 as a result of S1008. A confirmation screen 1400 includes a preview image display area 1401, a result display area 1402, a next button 1403, and an end button 1404.

The result display area 1402 is an area to display character strings 1421 and 1422 determined as the extraction target character strings. Specifically, in the present embodiment, the character strings corresponding to the issuance destination company name, the issuance destination person-in-charge name, the issuance source company name, and the issuance source person-in-charge name are displayed. By pressing edit buttons 1431 and 1432, the user can correct the character strings 1421 and 1422 determined as the extraction target character strings. Thus, any errors in the OCR result and the like can be corrected. The preview image display area 1401 is where the document image is displayed, and areas containing the character strings 1421 and 1422 displayed in the result display area 1402 are highlighted.

In response to pressing the next button 1403, the information processing unit 131 determines not to terminate the processing yet in S1009, so that the processes of S1002 to S1007 will be repeated to execute the process of determining the extraction target items in the next document image. On the other hand, in response to pressing the end button 1404, the information processing unit 131 determines to terminate the processing in S1009, so that the flowchart of FIG. 10 ends.

As described above, in the present embodiment, trained models generated by machine learning are used to determine the document type of a document image and candidate character strings as extraction target character strings. Moreover, by using a rule-based algorithm which makes determinations based on predefined combinations of document types and descriptions, appropriate extraction target character strings can be determined from among the candidate character strings. Thus, in the present embodiment, both trained models and a rule-based algorithm are used to determine the extraction target character strings. It is possible to improve the accuracy of determination of the extraction target character strings by combining determination of the document type and the candidate character strings using trained models which excel at information extraction, and a process of determining the extraction target character strings which involves executing processes based on knowledge, experiences, and the like with an algorithm. Also, by combining trained models which excel at information extraction and an algorithm in which complicated determination conditions are described as rules, it is possible to easily generate the trained models and design the algorithm.

Thus, in accordance with the present embodiment, it is possible to determine extraction target character strings in a document image which can be extracted by understanding the relationship between the character strings (context) in the document image with layout information of the document image taken into account. Accordingly, it is possible to determine extraction target character strings from a document image created with an unusual layout, which is generally called a semi-standardized document or a non-standardized document, with less burdens.

### Second Embodiment

In the method described in the first embodiment, a single character string is determined for a single extraction target item and presented to the user. In a second embodiment, a description will be given of a method in which multiple candidate character strings are determined for a single extraction target item and presented to the user to assist the user's correction.

FIG. 15 is a diagram for describing determination of extraction target character strings in the present embodiment. S1501 to S1503 in FIG. 15 are the same processes as S1301 to S1303 in FIG. 13, and description thereof is therefore omitted. The steps involving different processes from the steps in FIGS. 13 (S1504, S1505, and S1507) will be mainly described.

In S1504, the information processing unit 131 selects item values corresponding to item names each containing the processing target's status and “company name”. For example, in the case where the processing target is the buyer, then, if the column 1104 in FIG. 11C holding the item names in the document image contains the item names “orderer company name”, “billing destination company name”, and “delivery destination company name”, the information processing unit 131 selects the item values corresponding to these item names. Then, the information processing unit 131 selects the item values corresponding to the item names in descending order of the degree of priority of the status as candidate item values having high priority to be displayed to the user.

For example, in FIG. 11C, the record with the area ID “1121” includes the item name “orderer company name” containing the status with the highest degree of priority “1”, and holds the item value “DDD LLC” corresponding to this item name. Thus, the information processing unit 131 selects “DDD LLC” as the first candidate character string for the buyer company name. Likewise, the record with an area ID “1141” includes the item name “billing destination company name” containing the status with the second highest degree of priority “2”, and holds the item value “DDD LLC” corresponding to this item name. Also, the record with an area ID “1131” includes the item name “delivery destination company name” containing the status with a degree of priority “3”, and holds an item value “DDD Group” corresponding to this item name. Thus, the information processing unit 131 selects “DDD LLC” as the second candidate for the buyer company name and “DDD Group” as the third candidate for the buyer company name.

In S1505, the information processing unit 131 selects item values corresponding to item names each containing the status contained in the item name corresponding to an item value selected in S1504 and “person-in-charge name”. Then, the information processing unit 131 selects the item values corresponding to the item names in descending order of the degree of priority of the status as candidate item values having high priority to be displayed to the user.

In FIG. 11C, the record with the area ID “1122” holds the item value “Dana Morgan” corresponding to the item name “orderer person-in-charge name” containing the status “orderer” determined as the first candidate in S1504. Thus, the information processing unit 131 selects “Dana Morgan” as the first candidate character string for the buyer person-in-charge name. FIG. 11C does not include the item name “billing destination person-in-charge name” containing the status “billing destination” determined as the second candidate in S1504. The record with an area ID “1133” holds an item value “James A. Brown” corresponding to the item name “delivery destination person-in-charge name” containing the status “delivery destination” determined as the third candidate in S1504. Thus, the information processing unit 131 selects “James A. Brown” as the second candidate for the buyer person-in-charge name.

In S1507, the information processing unit 131 performs a process in which “company name” in S1504 is replaced with “person-in-charge name”.

S1506 and S1508 to S1512 are similar processes to S1306 and S1308 to S1312, and description thereof is therefore omitted. After finishing the processes of S1501 to S1511, the information processing unit 131 determines the extraction target character string and the change candidate character string for each extraction target item in S1512.

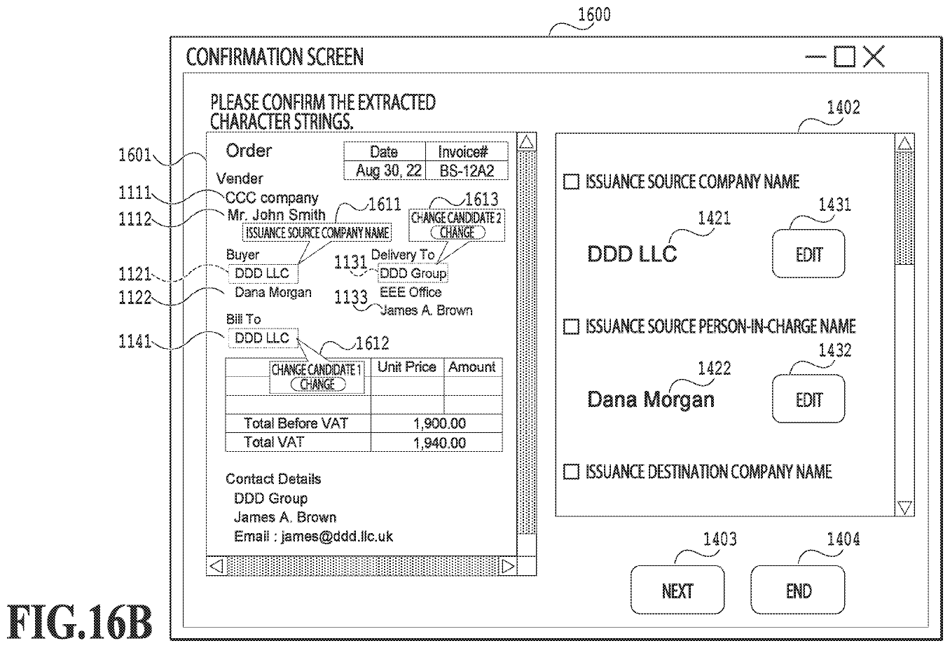

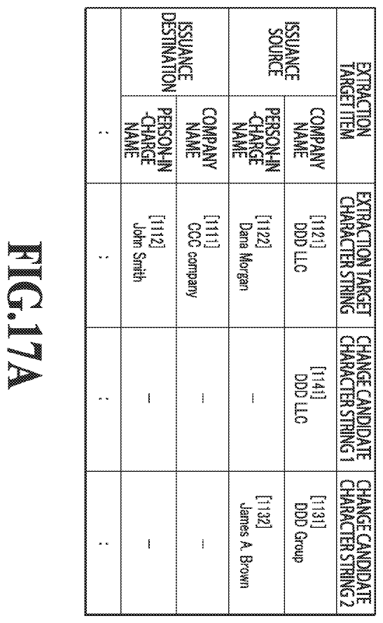

FIG. 16A is a diagram illustrating a list of extraction target character strings and candidate character strings determined from among the item names and item values included in FIG. 11C in the case where the buyer is determined to be the issuance source and the seller is determined to be the issuance destination.

In S1512, the information processing unit 131 determines the character strings selected as the first candidates as the extraction target character strings, the character strings selected as the second candidates as change candidate character strings 1, and the character strings selected as the third candidates as change candidate character strings 2. As a result, as illustrated in FIG. 16A, the first candidate character string “DDD LLC” for the buyer company name is determined as the extraction target character string for the issuance source company name, and the second candidate character string “DDD LLC” for the buyer company name is determined as the change candidate character string 1 for the issuance source company name. Moreover, the first candidate character string “Dana Morgan” for the buyer person-in-charge name is determined as the extraction target character string for the issuance source person-in-charge name.

FIG. 16B illustrates an example of a confirmation screen 1600 for displaying the extraction target character strings which is displayed based on display control by the information processing unit 131. In FIG. 16B, the same portions as those in the confirmation screen 1400 in FIG. 14B are denoted by the same reference signs. For example, the user can press the edit button 1431 to correct the character string 1421 determined as the issuance source company name.

In response to pressing the edit button 1431, a pop-up 1611 is displayed in a preview image display area 1601 at the position of the character string of the issuance source company name determined as the extraction target character string. Also, in the case where the change candidate character strings have been determined as illustrated in FIG. 16A, pop-ups 1612 and 1613 are displayed at the positions of the change candidate character strings for the issuance source company name in response to pressing the edit button 1431. Assume that the user has pressed the change button contained in one of the pop-ups 1612 and 1613 for the change candidate character strings. In this case, the information processing unit 131 corrects the current extraction target character string displayed in the result display area 1402 to the change candidate character string corresponding to the pop-up with the pressed change button. For example, in a case where the change button in the pop-up 1613 is pressed, the information processing unit 131 corrects the extraction target character string of the issuance source company name to the character string “DDD Group” corresponding to the pop-up 1613.

As described above, in accordance with the present embodiment, it is possible to present candidate character strings that are at lower levels than extraction target character strings to the user. This makes it possible to reduce the burden for the user to correct wrongly determined extraction target character strings.

### Modification 1

In the case of determining change candidate character strings for the company name of the buyer (seller) and the person-in-charge name of the buyer (seller), the change candidate character strings may be determined from among item names containing the same status for the company name and the person-in-charge name. For example, the candidate character strings for the buyer company name and the candidate character strings for the buyer person-in-charge name may be collectively determined based on the degrees of priority defined in FIG. 12B. In other words, S1504 and S1505 may be performed together.

The present modification in the case where the processing target is the buyer will now be described. For example, the information processing unit 131 selects the item values corresponding to item names containing “orderer”, which is the status with the degree of priority “1”, as the first candidates for the buyer company name and the buyer person-in-charge name. In FIG. 11C, the information processing unit 131 selects the item value “DDD LLC” corresponding to the item name “orderer company name” as the first candidate for the buyer company name and selects the item value “Dana Morgan” corresponding to the item name “orderer person-in-charge name” as the first candidate for the buyer person-in-charge name.

Likewise, the information processing unit 131 selects the item values corresponding to item names containing “billing destination”, which is the status with the degree of priority “2”, as the second candidates for the buyer company name and the buyer person-in-charge name. As a result, the item value “DDD LLC” corresponding to the item name “billing destination company name” is selected as the second candidate for the buyer company name. Also, since no item value has been extracted which corresponds to the item name “billing destination person-in-charge name”, the second candidate for the buyer person-in-charge name is not selected and is left blank. Likewise, the information processing unit 131 selects the item values corresponding to item names containing the character string “delivery destination”, which is the status with the degree of priority “3”, as the third candidates for the buyer company name and the buyer person-in-charge name. As a result, the item value “DDD Group” corresponding to the item name “delivery destination company name” is selected as the third candidate for the buyer company name, and the item value “James A. Brown” corresponding to the item name “delivery destination person-in-charge name” is selected as the third candidate for the buyer person-in-charge name.

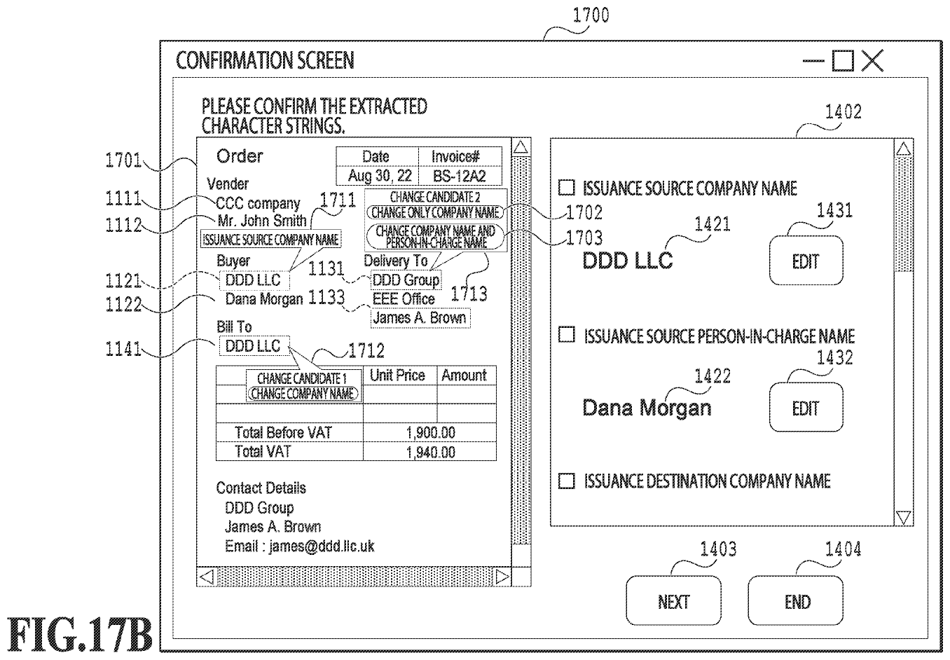

FIG. 17A is a diagram illustrating a list of extraction target character strings and change candidate character strings determined from FIG. 11C in the case where the buyer is determined to be the issuance source and the seller is determined to be the issuance destination. Unlike FIG. 16A, the change candidate character string 1 for the issuance source person-in-charge name is blank.

FIG. 17B illustrates an example of a confirmation screen 1700 for displaying the extraction target character strings which is displayed based on display control by the information processing unit 131. In FIG. 17B, the same portions as those in the confirmation screen 1600 in FIG. 16B are denoted by the same reference signs.

In the confirmation screen 1700, like FIG. 16B, in response to detecting the edit button 1431 for the issuance source company name being pressed by the user, a pop-up 1711 is displayed in a preview image display area 1701 at the position of the extraction target character string currently determined as the issuance source company name. Moreover, pop-ups 1712 and 1713 are displayed at the positions of the change candidate character strings for the issuance source company name.

Like the change candidate character strings 2 in FIG. 17A, there are cases where change candidate character strings at the same level are determined for both the company name and the person-in-charge name. In such a case, in the pop-up 1713 displayed at the position of the change candidate character strings 2, there are displayed both a button 1702 for changing only the company name and a button 1703 for changing the company name and the person-in-charge name. For example, assume that the button 1703 for changing the company name and the person-in-charge name is pressed. In this case, the information processing unit 131 corrects the extraction target character string for the issuance source company name to the change candidate character string 2 for the issuance source company name. Moreover, the information processing unit 131 corrects the extraction target character string for the issuance source person-in-charge name to the change candidate character string 2 for the issuance source person-in-charge name. Simultaneously performing corrections using change candidate character strings as described above reduces the user's effort.

As described above, in accordance with the present modification, it is possible to determine candidate character strings for extraction target items based on the same criterion with the relationship between the extraction target items taken into account. Thus, it is possible to simultaneously correct related extraction target character strings. This reduces the user's burden.

### Modification 2

In the above, a method in which a determined extraction target character string is corrected based on the user's instruction has been described. Based on the content of the correction, the degrees of priority associated with the corresponding statuses may be changed. Updating the degrees of priority enhances the accuracy of the next and subsequent determination of extraction target character strings.

For example, assume that the extraction target character strings and the change candidate character strings for the issuance source company name and the issuance source person-in-charge name have been determined as illustrated in FIG. 17A. Assume also that the user has then given an instruction to correct the character strings of the issuance source company name and the issuance source person-in-charge name to the respective change candidate character strings 2. In this case, the information processing unit 131 displays on the confirmation screen 1700 a confirmation message containing an option to change the degrees of priority of statuses in the next and subsequent operations based on the character strings selected by the user. In a case where the user chooses to change the statuses, the information processing unit 131 updates the degrees of priority associated with the statuses illustrated in FIG. 12B.

FIG. 18 is a diagram illustrating the degrees of priority associated with the buyer's statuses obtained by updating the degrees of priority associated with the buyer's statuses illustrated in FIG. 12B by the method of the present modification. For example, assume that the user has corrected the character string determined as an extraction target character string to the character string corresponding to an item name containing the delivery destination which has been determined as the change candidate character string 2. In this case, it is possible to consider that the user has selected the status “delivery destination” contained in the item name used in the correction. Thus, as illustrated in FIG. 18, the information processing unit 131 updates the degrees of priority such that the degree of priority of “delivery destination” is the highest. In this way, the next and subsequent times extraction target character strings are determined, the extraction target character strings will be determined on the basis of determination conditions based on the changed degrees of priority.

Incidentally, it is possible to set degrees of priority in association with statuses for each document type, and update the degrees of priority for each document type. For example, in a case where the document type is determined to be a purchase order in the process of determining extraction target character strings, the degrees of priority of the buyer's statuses for a purchase order may be updated as FIG. 18. In this case, the initial settings illustrated in FIG. 12B may be used for other document types. Moreover, the degrees of priority associated with the statuses may be updated for individual company names and person-in-charge names.

In accordance with the present modification described above, the determination conditions for determining extraction target character strings are updated based on the content of the user's instruction. Thus, the next and subsequent times extraction target character strings are determined, it is possible to determine ones that the user desires.

### Other Embodiments

In the above embodiments, the extraction target items are described as the issuance destination company name (person-in-charge name) and the issuance source company name (person-in-charge name). However, the extraction target items are not limited to these. For example, in a case where the information desired to be extracted from a document image is money, it includes various kinds of information such as “unit price”, “total without tax”, “total with tax”, and “balance due”, but the money information desired to be extracted is not sometimes included in the document image.

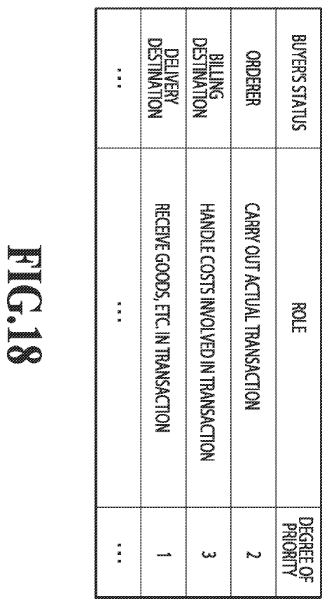

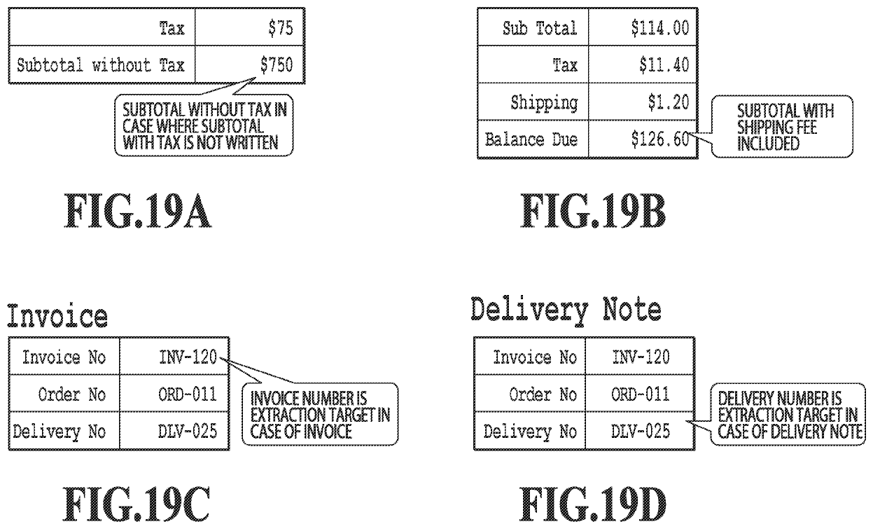

FIGS. 19A to 19D are diagrams for describing other examples of the extraction target items. For example, there is a case where an extraction target item is a price with tax but the price with tax is not written in the document, as illustrated in FIG. 19A. In this case, it will be impossible to determine a numeric string corresponding to the price with tax from the result of the estimation by the item value estimation model. In such a case, the information processing unit 131 determines a numeric string of other money information which can be determined from the result of the estimation by the item value estimation model, e.g., a numeric string corresponding to the price without tax. The information processing unit 131 then applies the numeric string corresponding to the price without tax thus determined to a preset rule-based algorithm to calculate the price with tax. The numeric string corresponding to the price with tax may be determined in this manner.

There is also a case where an extraction target item is a price with tax, but only a price with tax and a shipping fee is written in the document, as illustrated in FIG. 19B. In such a case, the information processing unit 131 may determine a numeric string corresponding to the price with tax by using the item value estimation model, and apply the numeric string thus determined to the rule-based algorithm to determine the numeric string corresponding to the price with tax without the shipping fee.

Also, the methods of the above embodiments are applicable to a case of extracting a character string corresponding to a document number assigned to a document from the document. A document may contain various document numbers. For example, as illustrated in FIG. 19C, in the case of an invoice, there may be written an invoice number (Invoice No.), an order number of the order (Order No.), and a delivery number if the invoice is issued after delivery (Delivery No.). Thus, in order to extract a document number assigned to a document from the document, it is necessary to understand each document number contained in the document and determine the document number considered appropriate as the extraction target based on the document type. For example, in the case of an invoice, it is necessary to determine the invoice number as the extraction target. Also, as illustrated in FIG. 19D, in the case of a delivery note, it is necessary to determine the delivery number as the extraction target document number. Also, in the case where no invoice number is written in an invoice and only a delivery number is written, it is necessary to determine that the extraction target document number is not present.

Thus, in a case where the extraction target item is a document number assigned to a document, an item value estimation model that estimates character strings corresponding to an invoice number, an order number, and a delivery number is generated. The information processing unit 131 uses this item value estimation model to determine the character strings corresponding to the invoice number, the order number, and the delivery number. Then, the information processing unit 131 applies the character strings corresponding to the invoice number, the order number, and the delivery number and the document type to a rule-based algorithm. The character string corresponding to the document number assigned to the document may be determined in this manner.

Also, from among dates included in a document indicating an invoice date, an order date, and a delivery date, an appropriate date needs to be determined as the issuance date of the document based on the document type. Thus, the issuance date of the document may be determined by using trained models and an algorithm with a method similar to that for determining a document number.

In accordance with the present disclosure, character strings which would increase burdens if estimated by a trained model can be appropriately extracted with less burdens.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-043940 filed Mar. 20, 2023, which is hereby incorporated by reference wherein in its entirety.

What is claimed is:

1. An information processing apparatus comprising:
an obtaining unit configured to obtain a token string generated based on character strings included in a document image;
a first determination unit configured to determine a document type represented by the document image and character strings corresponding to a first item included in the document image by using a result obtained by inputting the token string into a trained model; and
a second determination unit configured to determine a character string corresponding to a second item by applying the document type and the character strings corresponding to the first item to a rule-based algorithm.

2. The information processing apparatus according to claim 1, wherein the second determination unit determines the character string corresponding to the second item from among the character strings corresponding to the first item.

3. The information processing apparatus according to claim 1, wherein
the character strings corresponding to the first item and the character string corresponding to the second item are numeric strings, and
the second determination unit determines a numeric string obtained by performing a calculation with the numeric strings corresponding to the first item based on the algorithm as the numeric string corresponding to the second item.

4. The information processing apparatus according to claim 1, wherein the trained model includes a first trained model generated by performing machine learning so as to output a document type represented by a document image.

5. The information processing apparatus according to claim 4, wherein the trained model includes a second trained model generated by performing machine learning so as to output items corresponding to character strings included in a document image.

6. The information processing apparatus according to claim 5, wherein the first determination unit
determines the document type represented by the document image by using a result obtained by inputting the token string into the first trained model, and
determines the character strings corresponding to the first item included in the document image by selecting the first item from among items obtained by inputting the token string into the second trained model.

7. The information processing apparatus according to claim 1, wherein the trained model is a single trained model generated by performing machine learning so as to output a document type represented by a document image and items corresponding to character strings included in the document image.

8. The information processing apparatus according to claim 1, wherein
the algorithm is an algorithm in which a determination condition for determining the character string corresponding to the second item is set, and
the second determination unit determines the character string corresponding to the second item by applying at least one of the document type and the character strings corresponding to the first item to the determination condition.

9. The information processing apparatus according to claim 8, further comprising
a correction unit configured to correct the character string determined by the second determination unit to a character string designated by a user; and
an update unit configured to update information on the determination condition based on a content of the correction by the user.

10. The information processing apparatus according to claim 1, further comprising a display control unit configured to display the character string determined by the second determination unit on a display unit.

11. The information processing apparatus according to claim 10, wherein
the second determination unit further determines a candidate character string other than the character string corresponding to the second item,
the display control unit further displays the candidate character string, and
the information processing apparatus further comprises a correction unit configured to make a correction in a case where a user selects the candidate character string such that the candidate character string becomes the character string corresponding to the second item.

12. The information processing apparatus according to claim 10, wherein
the second item includes a plurality of items,
the second determination unit further determines candidate character strings other than the character strings corresponding to the plurality of items,
the display control unit further displays the candidate character strings corresponding to the plurality of items, and
the information processing apparatus further comprises a correction unit configured to correct the character strings corresponding to the plurality of items by using the candidate character strings corresponding to the plurality of items in a case where a user selects the candidate character string corresponding to one of the plurality of items.

13. The information processing apparatus according to claim 1, wherein the second item includes an item representing an issuance destination of a document represented by the document image and an item representing an issuance source of the document.

14. The information processing apparatus according to claim 13, wherein
the document represented by the document image is a document on selling of goods, and
the first item includes a plurality of items including an item indicating a company name of a seller or a name of a person in charge at the seller and an item indicating a company name of a buyer or a name of a person in charge at the buyer.

15. An information processing method comprising:
obtaining a token string generated based on character strings included in a document image;
determining a document type represented by the document image and character strings corresponding to a first item included in the document image by using a result obtained by inputting the token string into a trained model; and
determining a character string corresponding to a second item by applying the document type and the character strings corresponding to the first item to a rule-based algorithm.

16. A non-transitory computer readable storage medium storing a program which causes a computer to perform an information processing method, the information processing method comprising:
obtaining a token string generated based on character strings included in a document image;
determining a document type represented by the document image and character strings corresponding to a first item included in the document image by using a result obtained by inputting the token string into a trained model; and
determining a character string corresponding to a second item by applying the document type and the character strings corresponding to the first item to a rule-based algorithm.
